(19) United States
(12) Patent Application Publication
(10) Pub. No.: US 2018/0079596 A1
(43) Pub. Date: Mar. 22, 2018

(54) LINEAR RACK DEVICE AND METHOD FOR ASSEMBLING THE SAME

(71) Applicant: Bosch Rexroth (Changzhou) Co. Ltd., Wujin (CN)

(72) Inventors: Daniel Senft, Wujin (CN); Zhilei Ding, Wujin (CN)

(21) Appl. No.: 15/707,081

(22) Filed: Sep. 18, 2017

(30) Foreign Application Priority Data
Sep. 20, 2016 (CN) 201610836247.6

(51) Int. Cl. B65G 21/22; B65G 9/00

(52) U.S. Cl. CPC B65G 21/22; B65G 2812/188; B65G 9/008

(57) ABSTRACT

A linear rack device and a method for assembling the linear rack device. The linear rack device comprises a base, a rail secured on the base, and an end support for mounting a driving device. The method comprises securing the rail on the base; contacting at least two non-planar locating planes of the end support directly with at least two non-planar locating planes of the rail such that the end support is located with respect to the rail; and securing the end support to the base.

### BACKGROUND OF THE INVENTION

The present application relates to a linear rack device and a method for assembling it.

A linear rack device has been widely used in the field of industrial manufacturing. For example, the linear rack device generally comprises a linear rail and a slide movable back and forth on the linear rail. Take a packaging production line for example. A grabber can be provided on the slide such that a product can be carried from one position to another position.

This kind of linear rack device further comprises a base and a driving device by which the slide is driven to move. The driving device is secured by two end supports at both ends of the base. Usually, when the linear rack device is assembled, the linear rail is secured on the base. Independently from this, the two end supports are located and secured relative to the base respectively in a manner of pin-hole-cooperation. Such location and securing sometimes may not satisfy locating accuracy requirements between the end supports and the linear rail. If the locating accuracy requirements between the end supports and the linear rail are not satisfied, the driving device installed on the end support will generate a driving force on the slide, which driving force is not parallel to the linear rail's longitudinal direction, resulting in that the back and forth movement of the slide is constrained.

Furthermore, the manner of pin-hole-cooperation requires that a locating hole is machined in the base. However, since the base has a relatively great length, it is difficult to machine the locating hole in the base.

### SUMMARY OF THE INVENTION

In order to solve the shortcomings mentioned above, the present application is aimed at proposing a linear rack device and a method for assembling it such that the linear rack device can be readily assembled and its end support and base can be located with high accuracy.

According to one aspect, the present application provides a linear rack device, the linear rack device comprising a base, a rail secured on the base, and an end support for mounting a driving device, the driving device being able to drive a slide to move on the rail, wherein the end support has at least two non-planar locating planes which are used to directly contact at least two non-planar locating planes of the rail before the end support is secured, so as to ensure that the end support is able to be located with respect to the rail.

Optionally, an end of the rail at least partially extends outwards from the base, and the at least two non-planar locating planes of the end support are in direct contact with at least two non-planar locating planes of said end of the rail.

Optionally, the end support has a locating hole, and the locating plane of the end support is a wall plane of the locating hole.

Optionally, the locating hole is a blind hole, and the locating plane of the end support is formed in a bottom side of the blind hole.

Optionally, the locating planes of the end support are perpendicular to each other.

According to another aspect, the present application provides a method for assembling a linear rack device, the linear rack device comprising a base, a rail secured on the base, and an end support for mounting a driving device, the driving device being able to drive a slide to move on the rail, wherein the method comprises:

securing the rail on the base;

contacting at least two non-planar locating planes of the end support directly with at least two non-planar locating planes of the rail such that the end support is located with respect to the rail; and

securing the end support to the base.

Optionally, after the rail is secured on the base, an end of the rail at least partially extends outwards from base, and the at least two non-planar locating planes of the end support are in direct contact with at least two non-planar locating planes of said end of the rail.

Optionally, the locating planes of the end support are perpendicular to each other.

Optionally, the end support has a locating hole, and the locating plane of the end support used to contact the rail is a wall plane of the locating hole.

Optionally, the blind hole is a blind hole, and the locating plane of the end support is formed in a bottom side of the blind hole.

According to the technical solutions of the present application, the assembling procedure of the linear rack device can be simplified and the locating accuracy of the end support relative to the rail can be enhanced.

### BRIEF DESCRIPTION OF THE DRAWINGS

The forgoing and other aspects of the present application will be better understood by the following description in combination with the drawings. It should be noted that although the drawings might be given in different proportions, they cannot be deemed to affect understanding to the present application. In the drawings:

FIG. 1 is a perspective view schematically illustrating a linear rack device;

FIG. 2A is a perspective view schematically illustrating an end support according to one embodiment of the present application for the linear rack device;

FIG. 2B is a partial perspective view schematically illustrating how the end support shown by FIG. 2A is located and secured with a linear rail of the linear rack device; and

FIG. 3 is a partially cross-sectional and perspective view schematically illustrating how an end support according to another embodiment of the present application is located and secured with the linear rail of the linear rack device.

### DETAILED DESCRIPTION

It is noted that like reference numerals represent elements which have like or similar functions throughout the drawings.

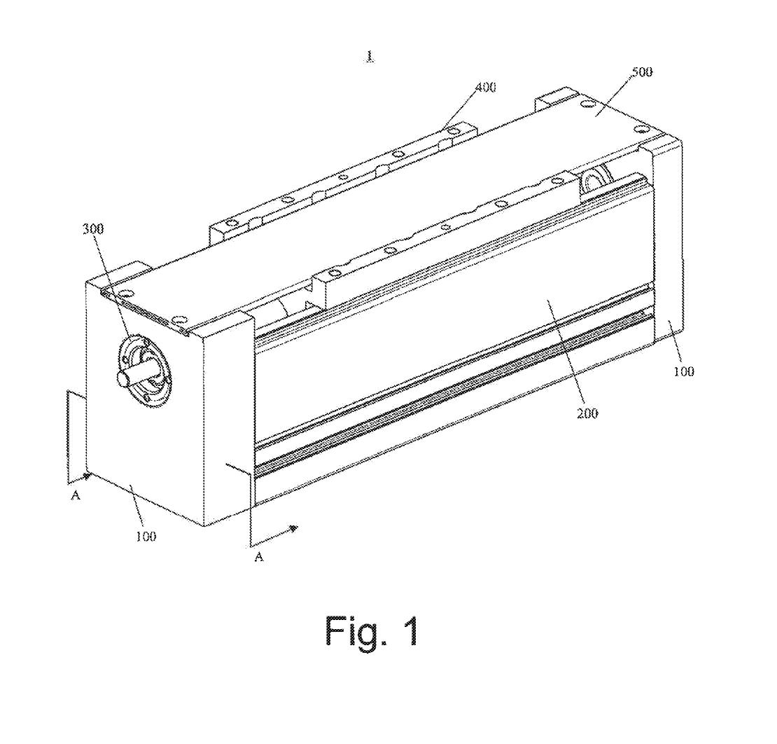

FIG. 1 schematically illustrates a linear rack device 1. It is understood by a person skilled in the art that the linear rack device 1 can be any device in the field of industrial manufacturing in which linear movement is required.

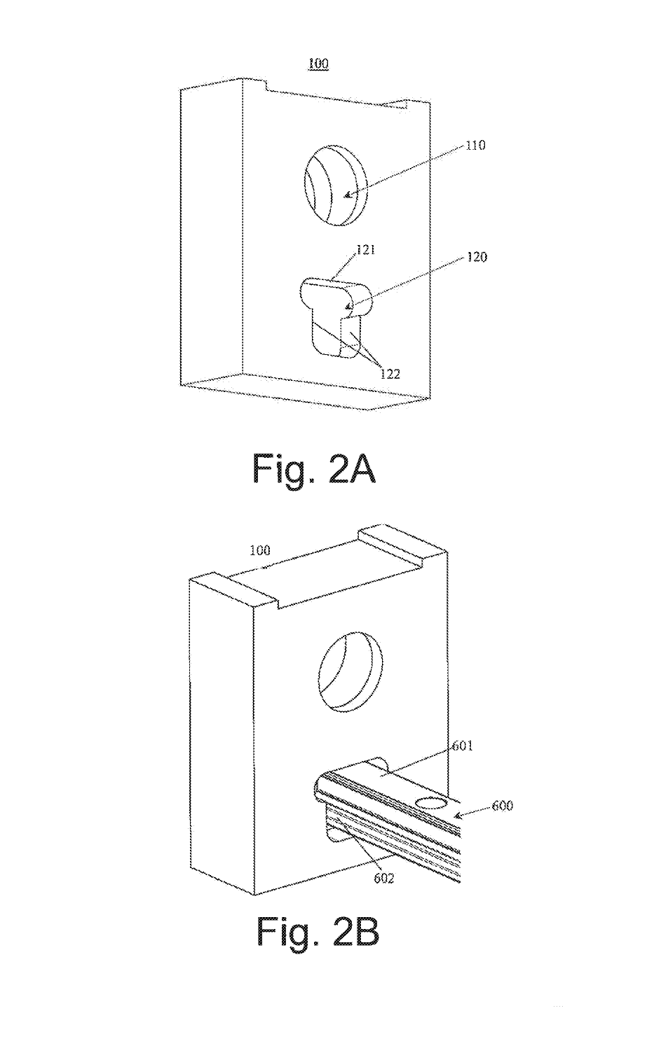

The linear rack device 1 comprises a base (not shown), two end supports 100 at both ends of the base respectively, two side plates 200 at both sides respectively, and a cover plate 500 covering on the end supports. A rail 600 (see FIG. 2B) is secured on the base. A slide is provided on the rail 600 such that it can be moved back and forth on the rail. The slide is operatively connected to a sliding racket 400 such that back and forth movement of the slide along the rail 600 can result in back and forth movement of the sliding bracket 400.

The cover plate 500 at least partially covers on the sliding bracket 400 to protect it. A plurality of mounting holes are provided in the sliding bracket 400 to receive accessories such as grasping arms

The two end supports 100 are used to mount a driving device 300 to drive the slide to move. In the illustrated embodiment, the driving device 300 can be a lead-screw-pair driving device having a rotatable lead screw arranged parallel to the rail 600 and a screw cooperating part operatively mating with the slide. By driving the lead screw to rotate, the slide can be driven to move linearly. Alternatively, the driving device 300 can be a belt-pulley driving device. No matter how to design the driving device 300, a driving force applied by the driving device 300 to the slide should be strictly parallel to a longitudinal direction of the rail 600. If the parallelism between them is poor, the movement of the slide will be constrained.

According to the prior art, in order to satisfy locating accuracy requirements between the rail 600 and the driving device 300, it is common to ensure the locating accuracy between the end support 100 and the rail 600 first. Such location between the end support 100 and the base is usually carried out in a pin-hole cooperation manner. This requires that a locating hole is machined in the end support and either end of the base such that a locating pin can be inserted into the locating hole. However, the linear rack device 1 is usually long, especially its base is usually long, having a length of at least 2 meters. Therefore, it is very difficult to machine a hole in either end of the base. Furthermore, the pin-hole cooperation manner requires that a separate locating step should be carried out when the linear rack device 1 is assembled.

Therefore, the present application proposes a novel method for locating and assembling the end support 100. Using the proposed locating and assembling method, the location between the end support 100 and the base will be carried out by locating the end support 100 directly with the rail 600, rather than by the pin-hole cooperation manner. Usually, the rail 600 is a component of standard format provided by suppliers. A locating plane of standard format has been already machined in the rail 600, for example in its top side, bottom side and lateral side. Locating the end support 100 directly with the rail 600 can not only dispense with the middle locating step such as of locating the end support, but also greatly improve the locating accuracy.

FIG. 2A illustrates a first embodiment of the end support 100 according to the present application, which is capable of being mounted in the linear rack device 1. According to the first embodiment, the end support 100 comprises a mounting hole 110 and a locating hole 120. The mounting hole 110 is used to mount the previously mentioned driving device 300 thereto. The locating hole 120 is used to receive the rail 600 and to be located with it.

For instance, the locating hole 120 is a blind hole having an opening towards one end of the rail 600. In the embodiment illustrated by FIG. 2A, the locating hole 120 is generally T-shaped. In manufacturing the end support 100, the locating hole 120 can be conveniently machined with a top locating plane 121 and a lateral locating plane 122 which satisfy the locating accuracy requirements. The top locating plane 121 and the lateral locating plane 122 are at an angle. Preferably, they are perpendicular to each other. A top locating plane 601 and a lateral locating plane 602 are in advance machined in the rail 600 in the same format as the top locating plane 121 and the lateral locating plane 122. In an alternative embodiment, the locating hole 120 can comprise two opposing lateral locating planes 122, and the rail 600 can comprise two opposite lateral locating planes 602.

In assembling the linear rack device 1, the rail 600 is first secured on the base of the linear rack device 1 such that two ends of the rail 600 are at least partially exposed from the base. Then, one top locating plane 121 and one lateral locating plane 122 of the end support 100 are enabled to respectively contact one top locating place 601 and one lateral locating plane 602 of the rail 600 such that the end support 100 is located precisely with respect to the rail 600. Then, the end support 100 can be secured to the base via any suitable technique known in the art and other component such as the driving device can be mounted subsequently.

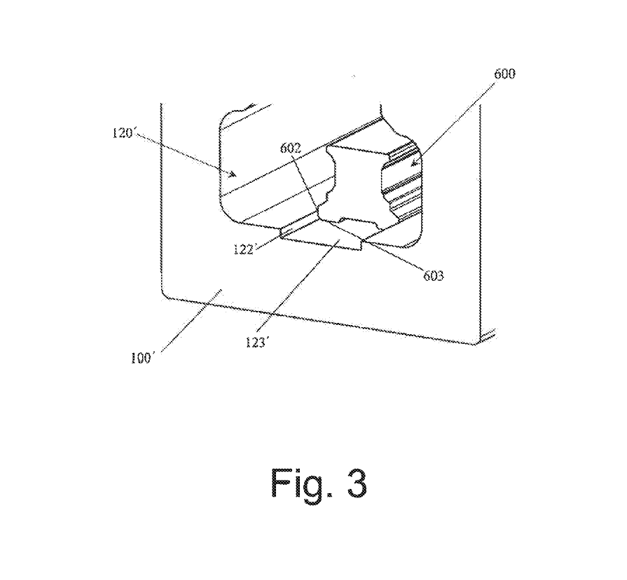

In the embodiment illustrated by FIGS. 2A and 2B, the end support 100 is located with respect to the rail 600 by contacting it with the top locating plane 121 and the lateral locating plane 122. FIG. 3 illustrates an end support 100′ according to another embodiment of the present application. In this embodiment, the end support 100′ is located with respect to the rail 600 by contacting it with a bottom locating plane and a lateral locating plane of the end support.

FIG. 3 is a partially cross-sectional and perspective view observed along a section A-A in FIG. 1. The end support 100′ also comprises a locating hole 120′. The locating hole 120′ is machined with a bottom locating plane 123′ and a lateral locating plane 122′. Similar to FIG. 2, the bottom locating plane 123′ and the lateral locating plane 122′ are at an angle. Preferably, they are perpendicular to each other. In an alternative embodiment, the lateral locating plane 122′ can comprise two lateral locating planes. A bottom locating plane 603 and a lateral locating plane 602 are in advance machined in the rail 600 in the same format as the bottom locating plane 123′ and the lateral locating plane 122′.

In this way, in assembling the linear rack device 1, the rail 600 is first secured on the base of the linear rack device 1 such that two ends of the rail 600 are at least partially exposed from the base. Then, one bottom locating plane 123′ and one lateral locating plane 122′ of the end support 100 are enabled to respectively contact one bottom locating place 603 and one lateral locating plane 604 of the rail 600 such that the end support 100 is located precisely with respect to the rail 600. Then, the end support 100 can be secured to the base via any suitable technique known in the art and other component such as the driving device can be mounted subsequently.

Therefore, it is unnecessary to machine a pin-hole in the end support 100 and the base respectively. Further, since a pin-hole locating step as required by the prior art is dispensed with, the procedure of assembling the device is simplified. It is important that since the end support is in direct contact with the rail and located with it, the locating accuracy of the end support is enhanced, that is, the locating accuracy of the driving device is enhanced such that the slide on the rail can be driven via a driving force satisfying the required precision.

Although in the illustrated embodiments the location is carried out via the top plane, the bottom plane or the lateral plane of the rail, it should be understood by the person skilled in the art that an end plane of the rail 600 can be used for contact-location if the end plane of the rail is machined with satisfied precision. In this case, for instance, a bottom plane of the locating hole 120 or 120′ formed as the blind hole can be machined as a locating plane, which is optionally used to contact a corresponding end locating plane of the rail to locate the end support.

It should be understood by the person skilled in the art that the locating plane of the end support is not limited to be formed in the locating hole. Rather, for example, the locating plane of the end support can be formed in a groove which is open from one side of the end support. In another alternative embodiment, the locating plane of the end support can be formed in a protrusion of the end support which protrudes from a side of the end support facing the rail. In this case, the locating plane of the end support can be enabled to contact the locating plane of the rail without extending the rail out of the base.

In all the embodiments of the present application, no matter how the respective locating planes of the end support 100 or 100′ and the rail 600 are chosen, each of them should have at least two locating planes, wherein the at least two locating planes should extend relative to each other at an angle (that is, they are non-planar).

In conclusion, the present application provides a linear rack device, the linear rack device comprising a base, a rail secured on the base, and an end support for mounting a driving device, the driving device being able to drive a slide to move on the rail, wherein the end support has at least two non-planar locating planes which are used to directly contact at least two non-planar locating planes of the rail before the end support is secured, so as to ensure that the end support is able to be located with respect to the rail.

Therefore, the present application also provides a method for assembling a linear rack device, the linear rack device comprising a base, a rail secured on the base, and an end support for mounting a driving device, the driving device being able to drive a slide to move on the rail, wherein the method comprises:

securing the rail on the base;

contacting at least two non-planar locating planes of the end support directly with at least two non-planar locating planes of the rail such that the end support is located with respect to the rail; and

securing the end support to the base.

Although some specific embodiments of the present application have been particularly described here, they are given for illustrative purposes only and cannot be deemed to limit the scope of the present application. Various replacements, modifications and alternations can be thought out without departing from the spirit and scope of the present application.

1. A linear rack device (1), the linear rack device (1) comprising a base, a rail (600) secured on the base, and an end support (100, 100′) for mounting a driving device (300), the driving device (300) being able to drive a slide to move on the rail (600), wherein the end support (100, 100′) has at least two non-planar locating planes which are used to directly contact at least two non-planar locating planes of the rail before the end support (100, 100′) is secured, so as to ensure that the end support is able to be located with respect to the rail (600).

2. The linear rack device (1) as recited in claim 1, wherein an end of the rail (600) at least partially extends outwards from the base, and the at least two non-planar locating planes of the end support (100, 100′) are in direct contact with at least two non-planar locating planes of said end of the rail.

3. The linear rack device (1) as recited in claim 1, wherein the end support (100, 100′) has a locating hole (120, 120′), and the locating plane of the end support (100) is a wall plane of the locating hole (120, 120′).

4. The linear rack device (1) as recited in claim 3, wherein the locating hole (120, 120′) is a blind hole, and the locating plane of the end support (100, 100′) is formed in a bottom side of the blind hole.

5. The linear rack device (1) as recited in claim 1, wherein the locating planes of the end support (100, 100′) are perpendicular to each other.

6. A method for assembling a linear rack device (1), the linear rack device (1) comprising a base, a rail (600) secured on the base, and an end support (100, 100′) for mounting a driving device (300), the driving device (300) being able to drive a slide to move on the rail (600), wherein the method comprises:
securing the rail (600) on the base;
contacting at least two non-planar locating planes of the end support (100, 100′) directly with at least two non-planar locating planes of the rail such that the end support is located with respect to the rail (600); and
securing the end support (600, 600′) to the base.

7. The assembling method as recited in claim 6, wherein after the rail (600) is secured on the base, an end of the rail (600) at least partially extends outwards from base, and the at least two non-planar locating planes of the end support (100, 100′) are in direct contact with at least two non-planar locating planes of said end of the rail.

8. The assembling method as recited in claim 6, wherein the locating planes of the end support (100, 100′) are perpendicular to each other.

9. The assembling method as recited in claim 6, wherein the end support (100, 100′) has a locating hole (120, 120′), and the locating plane of the end support (100, 100′) used to contact the rail is a wall plane of the locating hole (120, 120′).

10. The assembling method as recited in claim 9, wherein the blind hole (120, 120′) is a blind hole, and the locating plane of the end support (100, 100′) is formed in a bottom side of the blind hole.
